(19) United States
(12) Patent Application Publication
(10) Pub. No.: US 2026/0128971 A1
(43) Pub. Date: May 7, 2026

(54) RADIO LINK MONITORING FOR AIR-TO-GROUND NETWORKS

(71) Applicant: Apple Inc., Cupertino, CA (US)

(72) Inventors: Yuexia Song, Beijing (CN); Xiang Chen, Campbell, CA (US); Jie Cui, San Jose, CA (US); Qiming Li, Beijing (CN); Dawei Zhang, Saratoga, CA (US); Yang Tang, San Jose, CA (US); Manasa Raghavan, Sunnyvale, CA (US); Rolando E. Bettancourt Ortega, Munich, Bavaria-Bayern (DE)

(21) Appl. No.: 19/119,292

(22) PCT Filed: Oct. 11, 2022
(86) PCT No.: PCT/CN2022/124655

§ 371 Date: Apr. 8, 2025

(51) Int. Cl. H04L 43/0805; H04W 4/029; H04W 4/44

(52) U.S. Cl. CPC H04L 43/0805; H04W 4/029; H04W 4/44

(57) ABSTRACT

A UE includes a set of transceivers and a processor. The processor is configured to transmit an indication that the UE is operating in an air-to-ground (ATG) flight mode or an ATG ground mode. The indication that the UE is operating in the ATG flight mode or the ATG ground mode is based on location information of the UE. The processor is configured to receive a configuration that includes an out-of-sync threshold or an in-sync threshold. The out-of-sync threshold or the in-sync threshold is associated with the ATG flight mode or the ATG ground mode. The processor is configured to determine an out-of-sync indication or an in-sync indication based at least in part on the out-of-sync threshold or the in-sync threshold, and to transmit the out-of-sync indication or the in-sync indication. In some examples, the out-of-sync threshold or the in-sync threshold corresponds to a distance-based threshold or a time duration-based threshold.

### TECHNICAL FIELD

This application relates generally to wireless communication systems, including air-to-ground (ATG) networks.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example wireless communications system including an example UE and example ground stations of an ATG network.

FIG. 2 shows a first example method of wireless communication by a UE.

FIG. 3 shows a second example method of wireless communication by a UE.

FIG. 4 shows an example method of wireless communication by a network device.

FIG. 5 illustrates an example architecture of a wireless communication system, according to embodiments disclosed herein.

FIG. 6 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

3GPP systems such as, for example, NR, may support ATG network deployments. In some embodiments, an ATG network may provide in-flight connectivity for an aircraft, or devices therein, using ground stations or cell towers (i.e., network devices, which in some cases may include base stations). The ground stations of an ATG network can be similar to gNB deployments in terrestrial networks, but the antennas of a ground station of an ATG network may be oriented towards the sky. In some instances, the inter-site distance between ground stations of an ATG network may be larger than a typical range of distances between corresponding ground stations of terrestrial networks. In some embodiments, the aircraft in an ATG network may be an airplane, but it is not limited to such. For example, the aircraft may alternatively be a drone, a balloon, a blimp, a rocket, a low-orbiting satellite, or other type of airborne vehicle. For purposes of this description, an aircraft is just one type of UE that may communicate within an ATG network.

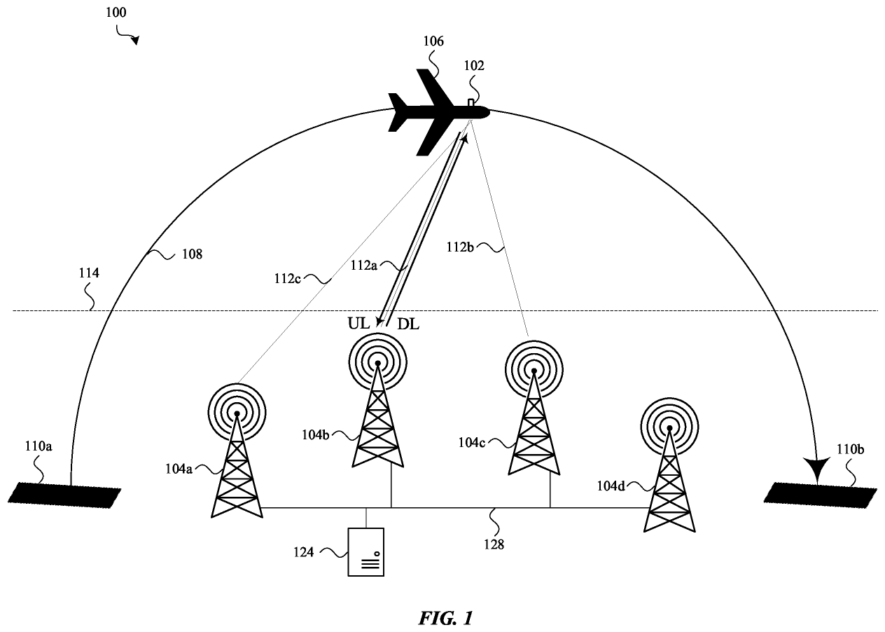

FIG. 1 illustrates an example wireless communications system 100 that may include an ATG network. The ATG network may include a UE 102 and multiple ground stations 104 (e.g., ground station 104a, ground station 104b, ground station 104c, and ground station 104d). In some embodiments, the UE 102 may be a component in an airplane 106 or other type of aircraft, for example, as part of or operatively coupled with a repeater device, router, Wi-Fi repeater, and access point, etc., with which other devices (e.g., passenger devices) may communicate. In some embodiments, the UE 102 may be a wireless device of a passenger on the airplane 106. The UE 102 may communicate with each of the ground stations 104 via uplink (UL) or downlink (DL) transmissions. As illustrated in FIG. 1, in an ATG network, a DL transmission may have a transmission path toward the airplane 106, and an UL transmission may have transmission path toward a ground station 104.

The ground stations 104 are shown arranged along a trajectory 108 that may constitute the flight path of the airplane 106. For example, the airplane 106 may depart from runway 110a ascend and travel along a flight path that passes through the cellular coverage area of ground station 104a, then to the cellular coverage area of ground station 104b, then to the cellular coverage area of ground station 104c, and then to the cellular coverage area of ground station 104d. The airplane 106 may then descend and land at runway 110b.

In some embodiments, a CN 124 may be connected to each of the ground stations 104. In some embodiment, each of the ground stations 104 may be configured with a central unit (CU), a distributed unit (DU), and a remote radio head (RRH). In some embodiments, the ATG network may include a RAN node that includes a CU configured to control transfer of user data between the RAN node and the other RAN nodes, thereby effecting mobility control, radio access network sharing, positioning, and session management for the UE 102. In some embodiments, the CU may be connected with a DU through an F1 interface, and the DU may be connected with the RRH through an F2 interface. The CN 124 may be communicatively coupled to the ground stations 104 or RAN nodes via an S1 or NG interface 128. In some embodiments, the CN 124 may be an EPC network, a 5GC network, or other type of CN. In some embodiments, the S1 or NG interface 128 may be split into an S1-U interface, which carries traffic data between the ground stations 104 or RAN nodes and a serving gateway (S-GW). The CN 124 may also include an S1-mobility management entity (MME) interface, which may be a signaling interface between the ground stations 104 or RAN nodes and one or more MMEs. When referencing a network or a network device as described herein, one or more components of the CN 124 and/or ground station 104 may be considered or implicated as the network or the network device in accordance with various embodiments.

As described herein, a UE 102 in the ATG network may be an ATG UE (e.g., a UE with one or more particular features that may be beneficial for use in an ATG network). For example, the ATG UE may be configured to be more powerful than a normal terrestrial UE. That is, for example, the UE 102 may be configured with a higher effective/equivalent isotropic radiated power (EIRP) via a larger transmission power and/or much larger on-board antenna gain. Additionally or alternatively, a ground station 104 in the ATG network may be an ATG base station (e.g., a gNB with one or more particular features that may be beneficial for use in an ATG network). In some instances, a large inter-site distance may exist between consecutive ground stations 104 (e.g., approximately 100-200 km). Moreover, when the airplane 106 travels above large bodies of water or sparsely populated land areas, the distance between the airplane 106 and a nearest ground station 104 can be even larger (e.g., up to 300 km). Accordingly, the ground stations 104 may be configured to provide up to 300 km cell coverage range in various embodiments.

Considering that ATG networks may have an advantage of (LOS) propagation conditions, radio link management (RLM) techniques may be optimized in accordance with the techniques described herein. In some embodiments, the airplane 106 may be on the runway 110a preparing to depart. The UE 102 may experience similar wireless characteristics during this timeframe as would a wireless device in a terrestrial network. That is, for example, reflected signals from buildings proximate to the runway 110a or other obstructions may create non-line of site (NLOS) transmission conditions for signals received or transmitted by the UE 102. Additionally, the UE 102 may be relatively stationary or moving at a slow speed while the airplane 106 is on the runway 110a. The UE 102 is capable of detecting conditions of speed and position, for example, to determine that the UE 102 is proximate to the ground (or airborne). In other words, the UE 102 may be location or positioning-capable in various embodiments. For example, the UE 102 may be capable of using global navigation satellite systems (GNSS) location or positioning techniques to determine the location or position of the UE 102. Additionally or alternatively, the UE 102 may use positioning-capable techniques to determine a speed at which the UE 102 is moving.

Based on the location or positioning information, the UE 102 may transmit to the network (e.g., to the nearest ground station 104a or the CN 124 via ground station 104a) an indication that the UE 102 is in a ground mode for the ATG network. Responsive to the indication, the network may provide a configuration that may be similar to a configuration in a terrestrial network. That is, for example, the ground station 104a may provide or otherwise indicate a default configuration for RLM procedures to be performed by the UE 102 when the UE 102 is in a ground mode (e.g., when airplane 106 is on runway 110a). In some embodiments, the UE 102 may monitor the DL radio link quality based on one or more RLM reference signals (RLM-RSs). The default configuration received by the UE 102 may include a set of RLM-RS resources and block error rate (BLER) thresholds. For example, a default configuration may include an out-of-sync BLER threshold (sometimes referred to as Qout) and an in-sync BLER threshold (sometimes referred to as Qin). In some embodiments, the default configuration (e.g., Configuration #0) may correspond to a Qout as 10% and a Qin as 2%.

In some instances, a configuration such as but not limited to a default configuration for Qout and Qin may be indicated to the UE 102 in an information element (e.g., ‘rlmInSyncOutOfSyncThreshold’) via radio resource control (RRC) signaling from a ground station 104. In some instances, for example, when UE 102 is not configured with an information element (e.g., ‘rlmInSyncOutOfSyncThreshold’), the UE 102 may know that the Qout is to be 10% and Qin is to be 2% as a default configuration (e.g., Configuration #0), and determine out-of-sync and in-sync block error rates accordingly. That is, for example, UE 102 may perform signal measurements on the RLM-RSs that are successfully transmitted within an evaluation period to determine a hypothetical BLER for physical downlink control channel (PDCCH) reception.

The UE 102 may compare the signal measurements performed during the transmission occasions within the evaluation period to the thresholds Qout and Qin in order to detect the DL radio link quality of the cell for a corresponding ground station 104 such as, for example, ground station 104a when the UE 102 is in the ground mode and airplane 106 is on departing runway 110a, or ground station 104d when the UE 102 is in the ground mode and airplane 106 is on arriving runway 110b. The UE 102 may determine if one or more RLM-RSs (e.g., all RLM-RSs in some cases) fall below that Qout threshold during the evaluation period and may transmit an out-of-sync indication when the UE 102 is in the ATG ground mode. Additionally or alternatively, the UE 102 may determine if one or more RLM-RSs (e.g., at least one RLM-RSs in some cases) exceed the Qin threshold during the evaluation period and may transmit an in-sync indication when the UE 102 is in the ATG ground mode.

Additionally or alternatively, in some embodiments, the UE 102 may determine if one or more RLM-RSs (e.g., all RLM-RSs in some cases) fall below a Qout link recovery (LR) threshold during the evaluation period and may transmit a beam failure instance indication when the UE 102 is in the ATG ground mode. In some embodiments, the Qout_LR threshold may be specified to the UE 102 via higher layer protocols (e.g., the medium access control (MAC) layer or the RRC layer). In some embodiments, the determination of the out-of-sync indication(s), the in-sync indication(s), and/or the beam failure instance indication(s) may be performed at the Physical (PHY) layer and reported to higher protocol layers. That is, for example, the out-of-sync indication(s) and/or the in-sync indication(s) may be reported to the RRC layer for evaluation of conditions for radio link failure (RLF) and/or to trigger a RLF and RRC re-establishment procedures. The beam failure instance indication(s) may be reported to the MAC layer for evaluation of conditions for beam failure and/or to trigger beam failure and beam failure recovery procedures.

When the airplane 106 is in flight mode, the UE 102 may experience different wireless characteristics as compared to a wireless device in a terrestrial network. For example, the propagation condition between UE 102 and ground stations 104 can be assumed to be LOS in some instances. Accordingly, in some embodiments, different Qout and Qin thresholds may be established for optimizing service and operation of the UE 102 in the airplane 106. Additionally, the airplane 106 may be travelling at very high speeds while in flight (e.g., up to 1200 km/h in some cases). Accordingly, operation of the UE 102 may also benefit from evaluation periods for determining out-of-sync and/or in-sync conditions as well as beam failure instances while in flight that are different from the evaluation period utilized in instances when the UE 102 is in the ATG ground mode.

In some embodiments, the airplane 106 with UE 102 may ascend above an altitude threshold 114. The network may determine the altitude threshold 114 based on particular aspects of the ATG network in a given deployment (e.g., a primarily mountainous or flat plains trajectory 108, changes in altitude along the trajectory 108, etc.). In some embodiments, the altitude threshold 114 may be established as a threshold for which all ATG deployments in a continental or other geographical area may utilize regardless of the particular ATG deployment. As illustrated in the non-limiting example of FIG. 1, the airplane 106 may ascend in flight along the trajectory 108 such that it is in the cell coverage area of ground station 104b, and ground station 104b may be the serving cell for the UE 102. The UE 102 may determine a location or positioning information, and based on the location or positioning information, the UE 102 may transmit to the network (e.g., to ground station 104b or the CN 124 via ground station 104b) an indication that the UE 102 is in a flight mode for the ATG network. Responsive to the indication, the network may provide one or more configurations to the UE 102.

In some embodiments, the network may provide BLER thresholds in a configuration to be used when the UE 102 is in the ATG flight mode. The ground station 104b may send to the UE 102 a configuration for Qout and Qin thresholds different from the default configuration (e.g., Configuration #0). That is, for example, the ground station 104b may indicate a Qout is to be [x]% and a Qin is to be [y]% in an information element (e.g., ‘rlmInSyncOutOfSyncThreshold’) via RRC signaling. The information element (e.g., ‘rlmInSyncOutOfSyncThreshold’) may indicate that the Qout is to be [x]% and the Qin is to be [y]% as a specific configuration (e.g., Configuration #1). In some non-limiting examples, Qout may be 5% and Qin may be 1% in Configuration #1. That is, the BLER threshold values for determining out-of-sync and in-sync conditions in ATG networks can be lowered from the default BLER threshold values based on the propagation condition being more manageable by the UE 102 due to the line of site transmission for the ground stations 104. Additionally or alternatively, the network may configure UE 102 with BLER threshold values that are used in a non-terrestrial network (NTN). That is, for example, the satellite-specific BLER thresholds used in an NTN may be used by the UE 102 when in the ATG flight mode as a means to reduce the out-of-sync probability for the UE 102 deployed in the ATG network.

In some embodiments, the network may send the various configurations (e.g., Configuration #1, ATG-specific thresholds, NTN-specific thresholds applicable to ATG networks, or other out-of-sync and in-sync thresholds discussed herein) when the UE 102 has reached the altitude threshold 114. That is, for example, when UE 102 transmits an indication that the UE 102 is in the ATG flight mode, but is at an altitude below altitude threshold 114. The network may send or indicate that the default configuration (e.g., Configuration #0) used when the UE 102 is in the ATG ground mode is to be used even though the UE 102 is presently in the ATG flight mode. In some embodiments, the UE 102 includes the location or position information in a transmission to the network in addition to the indication of the ATG flight mode, and the network sends the appropriate configuration to the UE 102 responsive to the transmission(s) based on the UE 102 being in the flight mode and the location or position information.

In some embodiments, the network sends multiple configurations (e.g., Configuration #0 and Configuration #1) in an information element (e.g., ‘rlmInSyncOutOfSyncThreshold’) including, or contemporaneous with, altitude threshold 114. In such embodiments, the UE 102 knows whether to use Configuration #0 or Configuration #1 based on the location or positioning information. Additionally or alternatively, in some embodiments, the UE 102 may know the altitude threshold 114 a priori and the network need not send the altitude threshold 114. In some embodiments, the location or positioning information of the UE 102 transmitted to the network may serve as the indication of the ATG mode (e.g., and the network determines whether the UE is in the ATG ground mode or the ATG flight mode). Other ATG mode and location or positioning information techniques between the UE 102 and the network are contemplated as would be understood by a person skilled in the art given the benefit of the present disclosure.

Additionally or alternatively, the network may indicate to the UE 102 a configuration that includes an out-of-sync threshold or an in-sync threshold that is distance-based. That is, for example, when UE 102 transmits an indication that the UE 102 is in the ATG flight mode and satisfies the altitude threshold 114, the network may send a configuration that includes a distance difference threshold indicative of the out-of-sync threshold (e.g., DDout) and/or a distance difference threshold indicative of the in-sync threshold (e.g., DDin). In some embodiments, the network may provide the distance-based thresholds in a configuration to be used when the UE 102 is in the ATG flight mode. In some embodiments, the ground station 104b may send to the UE 102 a configuration for DDout or DDin thresholds that includes a default configuration (e.g., Configuration #0) that may be used in the ATG flight mode when no other configuration is specified for the UE 102. For example, the ground station 104b may indicate DDout and DDin for Configuration #0 in an information element via RRC signaling. Additionally or alternatively, the DDout and/or DDin threshold values for Configuration #0 may be known by the UE 102 or hardcoded (e.g., with respect to a particular 3GPP standard and/or standards release).

In some embodiments, an information element (e.g., ‘rlmInSyncOutOfSyncThreshold-dd’) may indicate that the DDout is to be [A0] km and the DDin is to be [B0] km as a specific configuration (e.g., Configuration #0) and that the DDout is to be [A1] km and the DDin is to be [B1] km as a specific configuration (e.g., Configuration #1), where each of A0, B0, A1, and B1 may be different values.

In some embodiments, the UE 102 may use DDout or DDin in a similar manner as the BLER-based thresholds, Qout or Qin, for determining out-of-sync indication(s), in-sync indication(s), and/or beam failure instance indication(s). However, in some instances, the procedures for determining out-of-sync indication(s), in-sync indication(s), and/or the beam failure instance indication(s) need not be based on an evaluation period when distance-based thresholds are used. In some embodiments, the UE 102 may receive broadcast messages or other signaling from the ground stations 104 including an indication of their respective locations. That is, for example, the cells of ground stations 104 may be location or positioning-capable (e.g., using GNSS techniques) in various embodiments.

In some embodiments, to determine an out-of-sync indication, the UE 102 may determine a first distance 112a to the serving cell of the UE 102 (e.g., ground station 104b). The UE 102 may also determine a second distance 112b to a next cell after the serving cell in the trajectory 108 (e.g., ground station 104c). The UE 102 may then calculate an actual distance difference between the first distance 112a and the second distance 112b. The UE 102 may compare the actual distance difference to the DDout threshold value, and if the actual distance difference is larger than the DDout threshold value, the UE 102 may transmit an out-of-sync indication.

In some embodiments, to determine an in-sync indication, the UE 102 may determine a first distance 112a to the serving cell of the UE 102 (e.g., ground station 104b). The UE 102 may also determine a third distance 112c to a last cell before the serving cell in the trajectory 108 (e.g., ground station 104a). The UE 102 may then calculate an actual distance difference between the first distance 112a and the third distance 112c. The UE 102 may compare the actual distance difference to the DDin threshold value, and if the actual distance difference is smaller than the DDin threshold value, the UE 102 may transmit an in-sync indication.

Additionally or alternatively, in some embodiments, the UE 102 may determine if the actual distance difference between the first distance 112a and the second distance 112b is larger than a DDout LR threshold. If so, the UE 102 may transmit a beam failure instance indication when the UE 102 is in the ATG flight mode. In some embodiments, the DDout_LR threshold may be specified to the UE 102 via higher layer protocols (e.g., the MAC layer or the RRC layer). In some embodiments, the determination of the out-of-sync indication(s), the in-sync indication(s), and/or the beam failure instance indication(s) may be performed at the PHY layer and reported to higher protocol layers. That is, for example, the out-of-sync indication(s) and/or the in-sync indication(s) may be reported to the RRC layer for evaluation of conditions for RLF and/or to trigger RLF and RRC re-establishment procedures. The beam failure instance indication(s) may be reported to the MAC layer for evaluation of conditions for beam failure and/or to trigger a beam failure and beam failure recovery procedures.

In some examples, the network may indicate to the UE 102 a configuration that includes an out-of-sync threshold or an in-sync threshold that is time duration-based. That is, for example, when UE 102 transmits an indication that the UE 102 is in the ATG flight mode and satisfies the altitude threshold 114, the network may send a configuration that includes a time difference threshold indicative of the out-of-sync threshold (e.g., TDout) and/or a time difference threshold indicative of the in-sync threshold (e.g., TDin). In some embodiments, the network may provide the time duration-based thresholds in a configuration to be used when the UE 102 is in the ATG flight mode. In some embodiments, the ground station 104b may send to the UE 102 a configuration for TDout or TDin thresholds that includes a default configuration (e.g., Configuration #0) that may be used in the ATG flight mode when no other configuration is specified for the UE 102. Additionally or alternatively, the TDout and/or TDin threshold values for Configuration #0 may be known by the UE 102 or hardcoded (e.g., with respect to a particular 3GPP standard and/or standards release).

In some embodiments, an information element (e.g., ‘rlmInSyncOutOfSyncThreshold-td’) may indicate that the TDout is to be [C0] microseconds and the TDin is to be [D0] microseconds as a specific configuration (e.g., Configuration #0) and that the TDout is to be [C1] microseconds and the TDin is to be [D1] microseconds as a specific configuration (e.g., Configuration #1), where each of C0, D0, C1, and D1 may be different values. In some embodiments, the time-duration values may be expressed in periods rather than microseconds.

In some embodiments, the UE 102 may use TDout or TDin in a similar manner as the BLER-based thresholds, Qout or Qin, for determining out-of-sync indication(s), in-sync indication(s), and/or beam failure instance indication(s). However, in some instances, the procedures for determining out-of-sync indication(s), in-sync indication(s), and/or the beam failure instance indication(s) need not be based on an evaluation period when time duration-based thresholds are used. In some embodiments, the UE 102 may use system frame number (SFN) and Frame Timing Difference (SFTD) measurement techniques to determine time durations between the UE 102 and the ground stations 104 in various embodiments.

In some embodiments, to determine an out-of-sync indication, the UE 102 may determine a first time duration (e.g. corresponding to a time duration of a signal traveling the first distance 112a) to the serving cell of the UE 102 (e.g., ground station 104b). The UE 102 may also determine a second time duration (e.g. corresponding to a time duration of a signal traveling the second distance 112b) to a next cell after the serving cell in the trajectory 108 (e.g., ground station 104c). The UE 102 may then calculate an actual time duration difference between the first time duration and the second time duration. The UE 102 may compare the actual time duration difference to the TDout threshold value, and if the actual time duration difference is larger than the TDout threshold value, the UE 102 may transmit an out-of-sync indication.

In some embodiments, to determine an in-sync indication, the UE 102 may determine a first time duration (e.g. corresponding to a time duration of a signal traveling the first distance 112a) to the serving cell of the UE 102 (e.g., ground station 104b). The UE 102 may also determine a third time duration (e.g. corresponding to a time duration of a signal traveling the third distance 112c) to a last cell before the serving cell in the trajectory 108 (e.g., ground station 104a). The UE 102 may then calculate an actual time duration difference between the first time duration and the third time duration. The UE 102 may compare the actual time duration difference to the TDin threshold value, and if the actual time duration difference is smaller than the TDin threshold value, the UE 102 may transmit an in-sync indication.

Additionally or alternatively, in some embodiments, the UE 102 may determine if the actual time duration difference between the first time duration and the second time duration is larger than a TDout LR threshold. If so, the UE 102 may transmit a beam failure instance indication when the UE 102 is in the ATG flight mode. In some embodiments, the TDout_LR threshold may be specified to the UE 102 via higher layer protocols (e.g., the MAC layer or the RRC layer). In some embodiments, the determination of the out-of-sync indication(s), the in-sync indication(s), and/or the beam failure instance indication(s) may be performed at the PHY layer and reported to higher protocol layers. That is, for example, the out-of-sync indication(s) and/or the in-sync indication(s) may be reported to the RRC layer for evaluation of conditions for RLF and/or to trigger RLF and RRC re-establishment procedures. The beam failure instance indication(s) may be reported to the MAC layer for evaluation of conditions for beam failure and/or to trigger a beam failure and beam failure recovery procedures.

In some embodiments, the DDout, DDin, TDout, and/or TDin threshold values may correspond to similar out-of-sync conditions or in-sync conditions as comparable BLER-based threshold values, but the DDout, DDin, TDout, and/or TDin threshold values may be optimized for ATG networks and/or may be easier to implement by the UE 102.

In some embodiments, the UE 102 may receive multiple distance-based and time duration-based threshold configurations. For example, an ASN.1 transfer syntax for an information element (e.g., ‘SpCellConfig’) received by the UE 102 may include distance-based threshold configurations (e.g., ‘rlmInSyncOutOfSyncThreshold-dd’ that may be enumerated as ‘{d1, d2}’). Additionally, or alternatively, the ASN.1 transfer syntax for the information element (e.g., ‘SpCellConfig’) received by the UE 102 may include time duration-based threshold configurations (e.g., ‘rlmInSyncOutOfSyncThreshold-td’that may be enumerated as ‘{t1, t2}’).

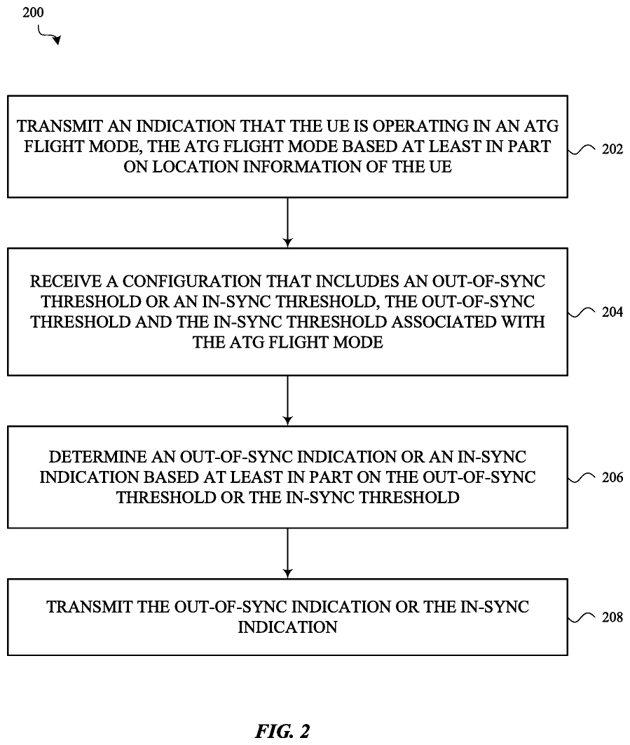

FIG. 2 shows a first example method 200 of wireless communication by a UE. The method 200 may be performed by the UE described with reference to FIG. 1 or by other UEs described herein. The method 200 may be performed using a processor, a set of transceivers (e.g., one or more transceivers), or other components of a UE.

At 202, the method 200 may include transmitting an indication that the UE is operating in an ATG flight mode. In some embodiments, the ATG flight mode is based at least in part on location information of the UE.

At 204, the method 200 may include receiving a configuration that includes an out-of-sync threshold or an in-sync threshold (and in some cases both). In some embodiments, the out-of-sync threshold and the in-sync threshold are associated with the ATG flight mode.

At 206, the method 200 may include determining an out-of-sync indication or an in-sync indication based at least in part on the out-of-sync threshold or the in-sync threshold.

At 208, the method 200 may include transmitting the out-of-sync indication or the in-sync indication.

The method 200 may be variously embodied, extended, or adapted, as described in the following paragraphs and elsewhere in this description.

In some embodiments of the method 200, for example, the out-of-sync threshold may correspond to at least one of a first distance-based threshold value or a first time duration-based threshold value. In some embodiments, the in-sync threshold may correspond to at least one of a second distance-based threshold value or a second time duration-based threshold value.

In some embodiments of the method 200, the out-of-sync threshold may be the first distance-based threshold value and the in-sync threshold may be the second distance-based threshold value. In some embodiments, the out-of-sync indication or the in-sync indication may be determined based at least in part on a first distance from the UE to a serving cell of the UE. In some embodiments, the out-of-sync indication may be determined based at least in part on a second distance from the UE to a next cell after the serving cell in a path of a plurality of cells that corresponds to an expected trajectory of the UE. In some embodiments, the in-sync indication may be determined based at least in part on a third distance from the UE to a last cell before the serving cell in the path of the plurality of cells that corresponds to the expected trajectory of the UE.

In some embodiments of the method 200, the out-of-sync threshold may be the first time duration-based threshold value, and the in-sync threshold may be the second time duration-based threshold value. In some embodiments, the out-of-sync indication or the in-sync indication may be determined based at least in part on a first time duration associated with a first transmission from the UE to a serving cell of the UE. In some embodiments, the out-of-sync indication may be determined based at least in part on a second time duration associated with a second transmission from the UE to a next cell after the serving cell in a path of a plurality of cells that corresponds to an expected trajectory of the UE. In some embodiments, the in-sync indication may be determined based at least in part on a third time duration associated with a third transmission from the UE to a last cell before the serving cell in the path of the plurality of cells that corresponds to the expected trajectory of the UE.

In some embodiments of the method 200, the configuration that includes the out-of-sync threshold and the in-sync threshold may include one or more distance-based thresholds. In some embodiments, the configuration that includes the out-of-sync threshold and the in-sync threshold may include one or more time duration-based thresholds. In some embodiments, the configuration that includes the out-of-sync threshold and the in-sync threshold may be received via RRC signaling.

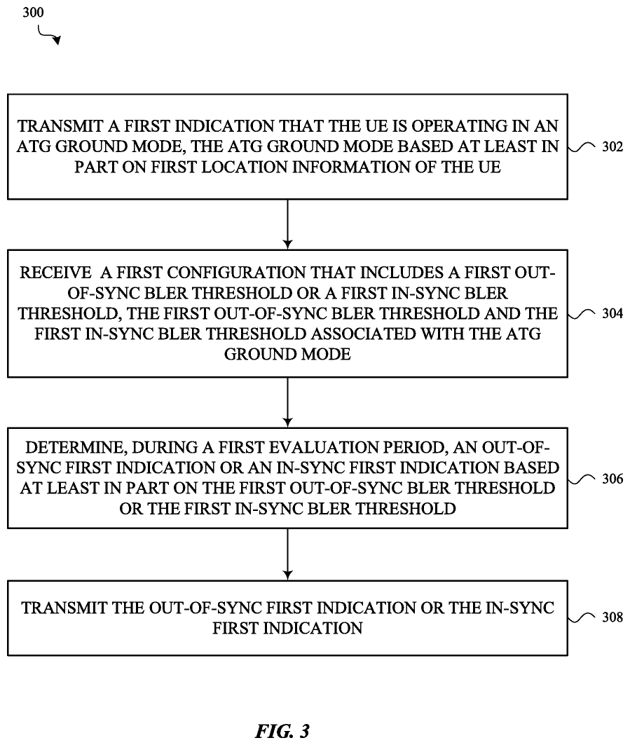

FIG. 3 shows a second example method 300 of wireless communication by a UE. The method 300 may be performed by the UE described with reference to FIG. 1 or by other UEs described herein. The method 300 may be performed using a processor, a set of transceivers (e.g., one or more transceivers), or other components of a UE.

At 302, the method 300 may include transmitting a first indication that the UE is operating in an ATG ground mode. In some embodiments, the ATG ground mode is based at least in part on first location information of the UE.

At 304, the method 300 may include receiving a first configuration that includes a first out-of-sync BLER threshold or a first in-sync BLER threshold. In some embodiments, the first out-of-sync BLER threshold and the first in-sync BLER threshold are associated with the ATG ground mode.

At 306, the method 300 may include determining, during a first evaluation period, an out-of-sync first indication or an in-sync first indication based at least in part on the first out-of-sync BLER threshold or the first in-sync BLER threshold.

At 308, the method 300 may include transmitting the out-of-sync first indication or the in-sync first indication.

The method 300 may be variously embodied, extended, or adapted, as described in the following paragraphs and elsewhere in this description.

In some embodiments of the method 300, for example, the first out-of-sync BLER threshold or the first in-sync BLER threshold may correspond to BLER thresholds for a terrestrial network. In some embodiments, the first evaluation period corresponds to an evaluation period for the terrestrial network.

In some embodiments, for example, a UE operating in accordance with aspects of the method 300 may transmit a second indication that the UE is operating in an ATG flight mode. In some embodiments, the ATG flight mode may be based at least in part on second location information of the UE. In some embodiments, the second location information may be different from the first location information. In some embodiments, for example, a UE operating in accordance with aspects of the method 300 may determine, during a second evaluation period, an out-of-sync or in-sync second indication based at least in part on the first out-of-sync BLER threshold or the first in-sync BLER threshold. In some embodiments of the method 300, the second evaluation period may correspond to an evaluation period for the ATG network and may have a duration that is different from a duration of the first evaluation period.

In some embodiments, for example, a UE operating in accordance with aspects of the method 300 may transmit a second indication that the UE is operating in an ATG flight mode. In some embodiments, the ATG flight mode may be based at least in part on second location information of the UE. In some embodiments, the second location information may be different from the first location information. In some embodiments, for example, a UE operating in accordance with aspects of the method 300 may receive a second configuration that includes a second out-of-sync BLER threshold or a second in-sync BLER threshold. In some embodiments, the second out-of-sync BLER threshold and the second in-sync BLER threshold may be associated with the ATG flight mode. In some embodiments, for example, a UE operating in accordance with aspects of the method 300 may determine an out-of-sync second indication or an in-sync second indication based at least in part on the second out-of-sync BLER threshold or the second in-sync BLER threshold.

In some embodiments, for example, a UE operating in accordance with aspects of the method 300 may transmit a second indication that the UE is operating in an ATG flight mode. In some embodiments, the ATG flight mode may be based at least in part on second location information of the UE. In some embodiments, the second location information may be different from the first location information. In some embodiments, for example, a UE operating in accordance with aspects of the method 300 may receive a second configuration that includes a second out-of-sync BLER threshold or a second in-sync BLER threshold. In some embodiments, the second out-of-sync BLER threshold and the second in-sync BLER threshold may be associated with the ATG flight mode. In some embodiments, for example, a UE operating in accordance with aspects of the method 300 may determine an out-of-sync second indication or an in-sync second indication based at least in part on the second out-of-sync BLER threshold or the second in-sync BLER threshold. In some embodiments, at least one of the second out-of-sync BLER threshold or the second in-sync BLER threshold may have a value different from a value of a corresponding one of the first out-of-sync BLER threshold or the first in-sync BLER threshold.

In some embodiments, for example, a UE operating in accordance with aspects of the method 300 may transmit a second indication that the UE is operating in an ATG flight mode. In some embodiments, the ATG flight mode may be based at least in part on second location information of the UE. In some embodiments, the second location information may be different from the first location information. In some embodiments, for example, a UE operating in accordance with aspects of the method 300 may receive a second configuration that includes an out-of-sync threshold or an in-sync threshold. In some embodiments, the out-of-sync threshold and the in-sync threshold may be associated with the ATG flight mode. In some embodiments, for example, a UE operating in accordance with aspects of the method 300 may determine an out-of-sync second indication or an in-sync second indication based at least in part on the out-of-sync threshold or the in-sync threshold. In some embodiments, the out-of-sync threshold may correspond to at least one of a first distance-based threshold value or a first time duration-based threshold value. In some embodiments, the in-sync threshold may correspond to at least one of a second distance-based threshold value or a second time duration-based threshold value. In some embodiments, a determination of the out-of-sync second indication or the in-sync second indication may be performed absent an evaluation period.

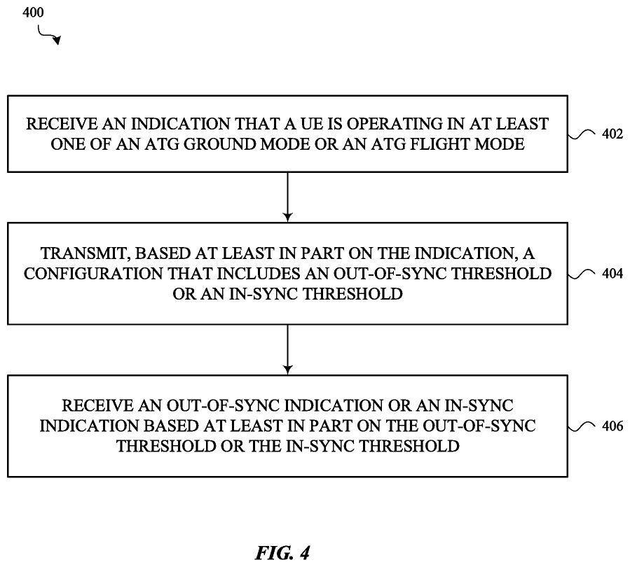

FIG. 4 shows an example method 400 of wireless communication by a network device. The method 400 may be performed by a ground station described with reference to FIG. 1 or by other network devices such as ground stations, base stations or CNs described herein. For example, the method 400 may be performed by a ground station 104 or CN 124. In some embodiments, the method 400 may be performed by the ground station 104 in communication with the CN 124. In some embodiments, the method 400 may be performed by the core network in communication with the ground station 104. The method 400 may be performed using a processor, a set of transceivers (e.g., one or more transceivers), or other components of a network device.

At 402, the method 400 may include receiving an indication that a UE is operating in at least one of an ATG ground mode or an ATG flight mode.

At 404, the method 400 may include transmitting, based at least in part on the indication, a configuration that includes an out-of-sync threshold or an in-sync threshold.

At 406, the method 400 may include receiving an out-of-sync indication or an in-sync indication based at least in part on the out-of-sync threshold or the in-sync threshold.

The method 400 may be variously embodied, extended, or adapted, as described in the following paragraphs and elsewhere in this description.

In some embodiments of the method 400, for example, the indication may be that the UE is operating in the ATG ground mode. In some embodiments, the out-of-sync threshold may include an out-of-sync BLER threshold or the in-sync threshold may include an in-sync BLER threshold. In some embodiments, the out-of-sync BLER threshold or the in-sync BLER threshold may be associated with the ATG ground mode.

In some embodiments of the method 400, the indication may be that the UE is operating in the ATG flight mode. In some embodiments, the out-of-sync threshold may include an out-of-sync BLER threshold or the in-sync threshold may include an in-sync BLER threshold. In some embodiments, the out-of-sync BLER threshold or the in-sync BLER threshold are associated with the ATG ground mode and an altitude of the UE that fails to satisfy an ATG threshold altitude.

In some embodiments of the method 400, the indication may be that the UE is operating in the ATG flight mode. In some embodiments, the out-of-sync threshold may include an out-of-sync BLER threshold or the in-sync threshold may include an in-sync BLER threshold. In some embodiments, the out-of-sync BLER threshold or the in-sync BLER threshold may be associated with the ATG flight mode and an altitude of the UE that satisfies an ATG altitude threshold.

In some embodiments of the method 400, the indication may be that the UE is operating in the ATG flight mode. In some embodiments, the out-of-sync threshold may include an out-of-sync distance-based threshold or the in-sync threshold may include an in-sync distance-based threshold. In some embodiments, the out-of-sync distance-based threshold or the in-sync distance-based threshold may be associated with the ATG flight mode and an altitude of the UE that satisfies an ATG altitude threshold.

In some embodiments of the method 400, the indication may be that the UE is operating in the ATG flight mode. In some embodiments, the out-of-sync threshold may include an out-of-sync time duration-based threshold or the in-sync threshold may include an in-sync time duration-based threshold. In some embodiments, the out-of-sync time duration-based threshold or the in-sync time duration-based threshold may be associated with the ATG flight mode and an altitude of the UE that satisfies an ATG altitude threshold.

Embodiments contemplated herein include an apparatus having means to perform one or more elements of the method 200, 300, or 400. In the context of method 200 or 300, the apparatus may be, for example, an apparatus of a UE (such as a wireless device 602 that is a UE, as described herein). As would be apparent given the benefit of the disclosure and embodiments described herein, in the complementary context of method 200 or 300, the apparatus may be, for example, an apparatus of a base station (such as a network device 620 that is a base station, as described herein). In the context of method 400, the apparatus may be, for example, an apparatus of a base station (such as a network device 620 that is a base station, as described herein) or a CN (such as a CN 524 that is a network device, as described herein).

Embodiments contemplated herein include one or more non-transitory computer-readable media storing instructions to cause an electronic device, upon execution of the instructions by one or more processors of the electronic device, to perform one or more elements of the method 200, 300, or 400. In the context of method 200 or 300, the non-transitory computer-readable media may be, for example, a memory of a UE (such as a memory 606 of a wireless device 602 that is a UE, as described herein). As would be apparent given the benefit of the disclosure and embodiments described herein, in the complementary context of method 200 or 300, the non-transitory computer-readable media may be, for example, a memory of a base station (such as a memory 624 of a network device 620 that is a base station, as described herein). In the context of method 400, the apparatus may be, for example, an apparatus of a base station (such as a memory 624 of a network device 620 that is a base station, as described herein) or a CN (such as a memory of CN 524 that is a network device, as described herein).

Embodiments contemplated herein include an apparatus having logic, modules, or circuitry to perform one or more elements of the method 200, 300, or 400. In the context of method 200 or 300, the apparatus may be, for example, an apparatus of a UE (such as a wireless device 602 that is a UE, as described herein). As would be apparent given the benefit of the disclosure and embodiments described herein, in the complementary context of method 200 or 300, the apparatus may be, for example, an apparatus of a base station (such as a network device 620 that is a base station, as described herein). In the context of method 400, the apparatus may be, for example, an apparatus of a base station (such as a network device 620 that is a base station, as described herein) or a CN (such as a CN 524 that is a network device, as described herein).

Embodiments contemplated herein include an apparatus having one or more processors and one or more computer-readable media, using or storing instructions that, when executed by the one or more processors, cause the one or more processors to perform one or more elements of the method 200, 300, or 400. In the context of method 200 or 300, the apparatus may be, for example, an apparatus of a UE (such as a wireless device 602 that is a UE, as described herein). As would be apparent given the benefit of the disclosure and embodiments described herein, in the complementary context of method 200 or 300, the apparatus may be, for example, an apparatus of a base station (such as a network device 620 that is a base station, as described herein). In the context of method 400, the apparatus may be, for example, an apparatus of a base station (such as a network device 620 that is a base station, as described herein) or a CN (such as a CN 524 that is a network device, as described herein).

Embodiments contemplated herein include a signal as described in or related to one or more elements of the method 200, 300, or 400.

Embodiments contemplated herein include a computer program or computer program product having instructions, wherein execution of the program by a processor causes the processor to carry out one or more elements of the methods 200, 300, or 400. In the context of method 200 or 300, the processor may be a processor of a UE (such as a processor(s) 604 of a wireless device 602 that is a UE, as described herein), and the instructions may be, for example, located in the processor and/or on a memory of the UE (such as a memory 606 of a wireless device 602 that is a UE, as described herein). As would be apparent given the benefit of the disclosure and embodiments described herein, in the complementary context of method 200 or 300, the processor may be a processor of a base station (such as a processor(s) 622 of a network device 620 that is a base station, as described herein), and the instructions may be, for example, located in the processor and/or on a memory of the base station (such as a memory 624 of a network device 620 that is a base station, as described herein). In the context of method 400, the processor may be a processor of a base station (such as a processor(s) 622 of a network device 620 that is a base station, as described herein), and the instructions may be, for example, located in the processor and/or on a memory of the base station (such as a memory 624 of a network device 620 that is a base station, as described herein). In some embodiments with respect to method 400, the processor may be a processor of a CN (such as a CN 524 that is a network device, as described herein), and the instructions may be, for example, located in the processor and/or on a memory of the CN (such as a memory of a CN 524 that is a network device, as described herein).

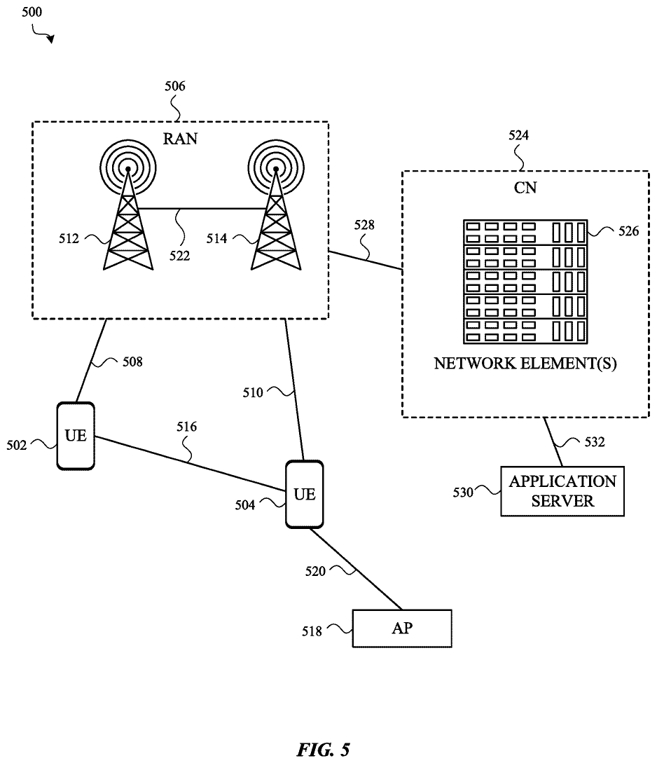

FIG. 5 illustrates an example architecture of a wireless communication system 500, according to embodiments disclosed herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also include any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which includes a physical communications interface. The RAN 506 can include one or more base stations, such as base station 512 and base station 514, that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can include a local wireless connection, such as a connection consistent with any IEEE 802.11 protocol, wherein the AP 518 may include a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can include a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 500 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 500 is an NR system (e.g., when CN 524 is a 5GC), the interface 522 may be an Xn interface. The Xn interface is defined between two or more base stations (e.g., two or more gNBs and the like) that connect to 5GC, between a base station 512 (e.g., a gNB) connecting to 5GC and an eNB, and/or between two eNBs connecting to 5GC (e.g., CN 524).

The RAN 506 is shown to be communicatively coupled to the CN 524. The CN 524 may include one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an SI interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, etc.) for the UE 502 and UE 504 via the CN 524. The application server 530 may communicate with the CN 524 through an IP communications interface 532.

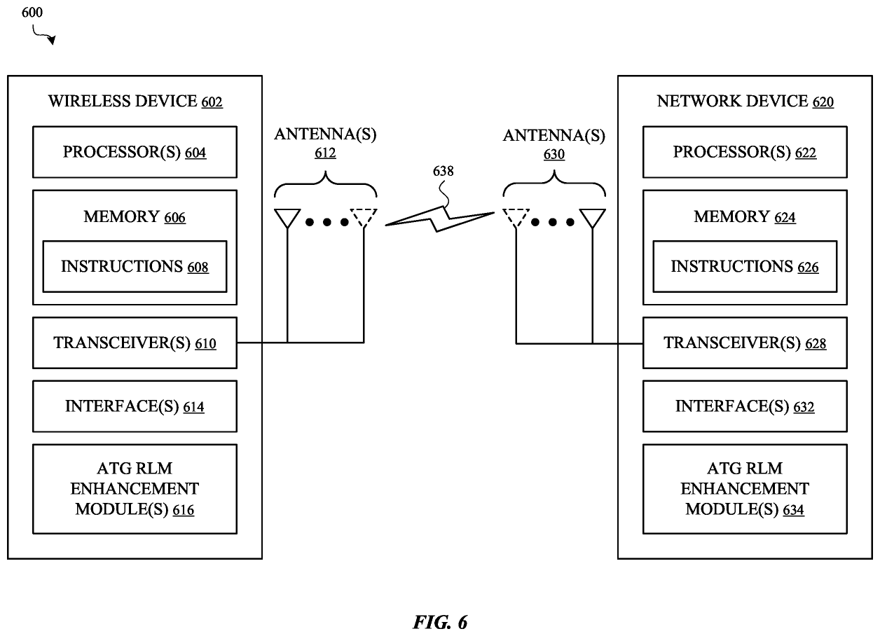

FIG. 6 illustrates a system 600 for performing signaling 638 between a wireless device 602 and a network device 620, according to embodiments disclosed herein. The system 600 may be a portion of a wireless communications system as herein described. The wireless device 602 may be, for example, a UE of a wireless communication system. The network device 620 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 638) to and/or from the wireless device 602 with other devices (e.g., the network device 620) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include an ATG RLM enhancement module 616. The ATG RLM enhancement module 616 may be implemented via hardware, software, or combinations thereof. For example, the ATG RLM enhancement module 616 may be implemented as a processor, circuit, and/or instructions 608 stored in the memory 606 and executed by the processor(s) 604. In some examples, the ATG RLM enhancement module 616 may be integrated within the processor(s) 604 and/or the transceiver(s) 610. For example, the ATG RLM enhancement module 616 may be implemented by a combination of software components (e.g., executed by a DSP or a general processor) and hardware components (e.g., logic gates and circuitry) within the processor(s) 604 or the transceiver(s) 610.

The ATG RLM enhancement module 616 may be used for various aspects of the present disclosure, for example, aspects of FIG. 1 through FIG. 4. The ATG RLM enhancement module 616 may be configured to, for example, apply or implement ATG RLM enhancement techniques described herein.

The network device 620 may include one or more processor(s) 622. The processor(s) 622 may execute instructions such that various operations of the network device 620 are performed, as described herein. The processor(s) 622 may include one or more baseband processors implemented using, for example, a CPU, a DSP, an ASIC, a controller, an FPGA device, another hardware device, a firmware device, or any combination thereof configured to perform the operations described herein.

The network device 620 may include a memory 624. The memory 624 may be a non-transitory computer-readable storage medium that stores instructions 626 (which may include, for example, the instructions being executed by the processor(s) 622). The instructions 626 may also be referred to as program code or a computer program. The memory 624 may also store data used by, and results computed by, the processor(s) 622.

The network device 620 may include one or more transceiver(s) 628 that may include RF transmitter and/or receiver circuitry that use the antenna(s) 630 of the network device 620 to facilitate signaling (e.g., the signaling 638) to and/or from the network device 620 with other devices (e.g., the wireless device 602) according to corresponding RATs.

The network device 620 may include one or more antenna(s) 630 (e.g., one, two, four, or more). In embodiments having multiple antenna(s) 630, the network device 620 may perform MIMO, digital beamforming, analog beamforming, beam steering, etc., as has been described.

The network device 620 may include one or more interface(s) 632. The interface(s) 632 may be used to provide input to or output from the network device 620. For example, a network device 620 that is a base station may include interface(s) 632 made up of transmitters, receivers, and other circuitry (e.g., other than the transceiver(s) 628 and antenna(s) 630 already described) that enables the base station to communicate with other equipment in a core network, and/or that enables the base station to communicate with external networks, computers, databases, and the like for purposes of operations, administration, and maintenance of the base station or other equipment operably connected thereto.

The network device 620 may include an ATG RLM enhancement module 634. The ATG RLM enhancement module 634 may be implemented via hardware, software, or combinations thereof. For example, the ATG RLM enhancement module 634 may be implemented as a processor, circuit, and/or instructions 626 stored in the memory 624 and executed by the processor(s) 622. In some examples, the ATG RLM enhancement module 634 may be integrated within the processor(s) 622 and/or the transceiver(s) 628. For example, the ATG RLM enhancement module 634 may be implemented by a combination of software components (e.g., executed by a DSP or a general processor) and hardware components (e.g., logic gates and circuitry) within the processor(s) 622 or the transceiver(s) 628.

The ATG RLM enhancement module 634 may be used for various aspects of the present disclosure, for example, aspects of FIG. 1 through FIG. 4. The ATG RLM enhancement module 634 may be configured to, for example, apply or implement ATG RLM enhancement techniques described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
one or more transceivers; and
a processor configured to,
transmit, via the one or more transceivers, an indication that the UE is operating in an air-to-ground (ATG) flight mode, the ATG flight mode based at least in part on location information of the UE;
receive, via the one or more transceivers, a configuration that includes an out-of-sync threshold or an in-sync threshold, the out-of-sync threshold and the in-sync threshold associated with the ATG flight mode, the out-of-sync threshold corresponds to at least one of a first distance-based threshold value or a first time duration-based threshold value, and the in-sync threshold corresponds to at least one of a second distance-based threshold value or a second time duration-based threshold value;
determine an out-of-sync indication or an in-sync indication based at least in part on the out-of-sync threshold or the in-sync threshold; and
transmit, via the one or more transceivers, the out-of-sync indication or the in-sync indication.

2. The UE of claim 1, wherein:
the out-of-sync threshold is the first distance-based threshold value;
the in-sync threshold is the second distance-based threshold value; and
the out-of-sync indication or the in-sync indication is determined based at least in part on a first distance from the UE to a serving cell of the UE.

3. The UE of claim 2, wherein:
the out-of-sync indication is further determined based at least in part on a second distance from the UE to a next cell after the serving cell in a path of a plurality of cells that corresponds to an expected trajectory of the UE; and
the in-sync indication is further determined based at least in part on a third distance from the UE to a last cell before the serving cell in the path of the plurality of cells that corresponds to the expected trajectory of the UE.

4. The UE of claim 1, wherein:
the out-of-sync threshold is the first time duration-based threshold value;
the in-sync threshold is the second time duration-based threshold value; and
the out-of-sync indication or the in-sync indication is determined based at least in part on a first time duration associated with a first transmission between the UE and a serving cell of the UE.

5. The UE of claim 4, wherein:
the out-of-sync indication is further determined based at least in part on a second time duration associated with a second transmission between the UE and a next cell after the serving cell in a path of a plurality of cells that corresponds to an expected trajectory of the UE; and
the in-sync indication is further determined based at least in part on a third time duration associated with a third transmission between the UE and a last cell before the serving cell in the path of the plurality of cells that corresponds to the expected trajectory of the UE.

6. The UE of claim 1, wherein the configuration that includes the out-of-sync threshold and the in-sync threshold includes one or more distance-based thresholds.

7. The UE of claim 1, wherein the configuration that includes the out-of-sync threshold and the in-sync threshold includes one or more time duration-based thresholds.

8. The UE of claim 1, wherein the configuration that includes the out-of-sync threshold and the in-sync threshold is received via radio resource control signaling.

9. A user equipment (UE), comprising:
one or more transceivers; and
a processor configured to,
transmit, via the one or more transceivers, a first indication that the UE is operating in an air-to-ground (ATG) ground mode, the ATG ground mode based at least in part on first location information of the UE;
receive, via the one or more transceivers, a first configuration that includes a first out-of-sync block error rate (BLER) threshold or a first in-sync BLER threshold, the first out-of-sync BLER threshold and the first in-sync BLER threshold associated with the ATG ground mode, the first out-of-sync BLER threshold or the first in-sync BLER threshold correspond to BLER thresholds for a terrestrial network, and the first evaluation period corresponds to an evaluation period for the terrestrial network;
determine, during a first evaluation period, an out-of-sync first indication or an in-sync first indication based at least in part on the first out-of-sync BLER threshold or the first in-sync BLER threshold; and
transmit, via the one or more transceivers, the first out-of-sync indication or the first in-sync first indication.

10. The UE of claim 9, wherein the processor is configured to:
transmit, via the one or more transceivers, a second indication that the UE is operating in an ATG flight mode, the ATG flight mode based at least in part on second location information of the UE, the second location information different from the first location information; and
determine, during a second evaluation period, an out-of-sync second indication or an in-sync second indication based at least in part on the first out-of-sync BLER threshold or the first in-sync BLER threshold; wherein,
the second evaluation period corresponds to an evaluation period for the ATG network and has a duration that is different from a duration of the first evaluation period.

11. The UE of claim 9, wherein the processor is configured to:
transmit, via the one or more transceivers, a second indication that the UE is operating in an ATG flight mode, the ATG flight mode based at least in part on second location information of the UE, the second location information different from the first location information;
receive, via the one or more transceivers, a second configuration that includes a second out-of-sync BLER threshold or a second in-sync BLER threshold, the second out-of-sync BLER threshold and the second in-sync BLER threshold associated with the ATG flight mode; and
determine an out-of-sync second indication or an in-sync second indication based at least in part on the second out-of-sync BLER threshold or the second in-sync BLER threshold.

12. The UE of claim 9, wherein at least one of the second out-of-sync BLER threshold or the second in-sync BLER threshold has a value different from a value of a corresponding one of the first out-of-sync BLER threshold or the first in-sync BLER threshold.

13. The UE of claim 9, wherein the processor is configured to:
transmit, via the one or more transceivers, a second indication that the UE is operating in an ATG flight mode, the ATG flight mode based at least in part on second location information of the UE, the second location information different from the first location information;
receive, via the one or more transceivers, a second configuration that includes an out-of-sync threshold or an in-sync threshold, the out-of-sync threshold and the in-sync threshold associated with the ATG flight mode, the out-of-sync threshold corresponds to at least one of a first distance-based threshold value or a first time duration-based threshold value, and the in-sync threshold corresponds to at least one of a second distance-based threshold value or a second time duration-based threshold value; and
determine an out-of-sync second indication or an in-sync second indication based at least in part on the out-of-sync threshold or the in-sync threshold.

14. The UE of claim 13, wherein a determination of the out-of-sync or in-sync second indication is performed absent an evaluation period.

15. A network device, comprising:
one or more transceivers; and
a processor configured to,
receive, via the one or more transceivers, an indication that a user equipment (UE) is operating in at least one of an air-to-ground (ATG) ground mode or an ATG flight mode;
transmit, via the one or more transceivers and based at least in part on the indication, a configuration that includes an out-of-sync threshold or an in-sync threshold; and
receive, via the one or more transceivers, an out-of-sync indication or an in-sync indication based at least in part on the out-of-sync threshold or the in-sync threshold.

16. The network device of claim 15, wherein:
the indication is that the UE is operating in the ATG ground mode; and
the out-of-sync threshold comprises an out-of-sync block error rate (BLER) threshold or the in-sync threshold comprises an in-sync BLER threshold, the out-of-sync BLER threshold and the in-sync BLER threshold associated with the ATG ground mode.

17. The network device of claim 15, wherein:
the indication is that the UE is operating in the ATG flight mode; and
the out-of-sync threshold comprises an out-of-sync block error rate (BLER) threshold or the in-sync threshold comprises an in-sync BLER threshold, the out-of-sync BLER threshold and the in-sync BLER threshold associated with the ATG ground mode and an altitude of the UE that fails to satisfy an ATG threshold altitude.

18. The network device of claim 15, wherein:
the indication is that the UE is operating in the ATG flight mode; and
the out-of-sync threshold comprises an out-of-sync block error rate (BLER) threshold or the in-sync threshold comprises an in-sync BLER threshold, the out-of-sync BLER threshold and the in-sync BLER threshold associated with the ATG flight mode and an altitude of the UE that satisfies an ATG altitude threshold.

19. The network device of claim 15, wherein:
the indication is that the UE is operating in the ATG flight mode; and
the out-of-sync threshold comprises an out-of-sync distance-based threshold or the in-sync threshold comprises an in-sync distance-based threshold, the out-of-sync distance-based threshold and the in-sync distance-based threshold associated with the ATG flight mode and an altitude of the UE that satisfies an ATG altitude threshold.

20. The network device of claim 15, wherein:
the indication is that the UE is operating in the ATG flight mode; and
the out-of-sync threshold comprises an out-of-sync time duration-based threshold or the in-sync threshold comprises an in-sync time duration-based threshold, the out-of-sync time duration-based threshold and the in-sync time duration-based threshold associated with the ATG flight mode and an altitude of the UE that satisfies an ATG altitude threshold.
